(19) United States
(12) Patent Application Publication
(10) Pub. No.: US 2024/0402043 A1
(43) Pub. Date: Dec. 5, 2024

(54) SYSTEM AND METHOD FOR TESTING OPTICAL DEVICES USING AN OPTICAL TIME DOMAIN REFLECTOMETER (OTDR) DEVICE

(71) Applicant: OFS FITEL, LLC, Norcross, GA (US)

(72) Inventor: Alan H McCurdy, Duluth, GA (US)

(73) Assignee: OFS FITEL, LLC, Norcross, GA (US)

(21) Appl. No.: 18/205,985

(22) Filed: Jun. 5, 2023

(51) Int. Cl. G01M 11/00

(52) U.S. Cl. CPC G01M 11/3172; G01M 11/319

(57) ABSTRACT

Embodiments of the invention include an optical time domain reflectometer (OTDR) device having a transmitter for transmitting a series of optical pulses, a processor for controlling the duration and frequency of the transmitted optical pulses, an optical coupler for directing the transmitted optical pulses to a device under test coupled to the OTDR and receiving light reflected back from the device under test, a detector for converting light reflected back from the device under test to an electrical signal, a display for displaying a plot of the electrical signal, and a gating function device for removing at least one saturation event from the light reflected back from the device under test. The operation of the gating function device is controlled by a gating signal provided by the processor to the gating function device. The gating signal is based on at least one characteristic of the saturation event.

### BACKGROUND OF THE INVENTION

### Field of Invention

The invention relates to systems, devices and methods for testing optical devices, such as optical fiber. More particularly, the invention relates to systems, devices and methods for testing optical devices using an optical time domain reflectometer (OTDR).

### Description of Related Art

An optical time domain reflectometer (OTDR) is a device used in the telecommunications industry for testing, troubleshooting, and characterizing optical fibers and other optical devices. An OTDR can measure optical fiber cabling properties such as breaks, connector loss, splice loss, optical fiber attenuation, attenuation coefficients, optical fiber length, and other parameters that affect the signal transmission quality through optical fiber and other optical devices.

In testing an optical fiber with an OTDR, optical pulses are launched into the optical fiber under test from a transmitter, e.g., a pulsed laser diode. During the time between the transmitted optical pulses, returned light from the optical fiber under test is reflected back to a detector in the form of backscatter and reflections associated with events, such as connectors and optical fiber irregularities. The detected light is then converted to an electrical signal and processed for display. The detected signal is displayed as an amplitude in decibels versus a length plot generally showing a gradually decreasing backscatter energy level with discrete reflective events appearing as pulses superimposed on the backscatter.

In using an OTDR to measure optical fiber attenuation, relatively strong back reflection from distal end facets of the optical fiber should be reduced to a relatively low value to avoid saturating the OTDR detector. When measuring optical fiber attenuation of conventional optical fiber, backreflection reduction can be accomplished in a number of ways, e.g., by properly cleaning optical fiber connectors, using angled cleaves, or by the use of an index-matching material. However, hollow core optical fiber typically is terminated by splicing or connection to a solid core optical fiber, so the end facet of the hollow core optical fiber often is not accessible. Thus, conventional backreflection reduction methods are not useful (or easily applied) in measuring hollow core optical fibers. Accordingly, relatively strong backreflection typically is unavoidable when measuring hollow core optical fibers using conventional methods. To properly measure hollow core optical fibers, it is necessary to protect the OTDR detector from such relatively strong back reflection.

### SUMMARY OF THE INVENTION

The invention is embodied in an optical time domain reflectometer (OTDR) device. The device includes a transmitter for generating and transmitting a series of optical pulses. The device also includes a processor coupled to the transmitter for controlling the duration and frequency of the optical pulses transmitted by the transmitter. The device also includes an optical coupler coupled to the transmitter for receiving the optical pulses from the transmitter. The optical coupler directs the optical pulses received from the transmitter to a device under test coupled to the OTDR and receives light reflected back from the device under test. The device also includes a detector coupled to the processor for receiving light reflected back from the device under test and converting the reflected light to an electrical signal. The device also includes a display coupled to the processor for displaying a plot of the electrical signal. The device also includes a gating function device coupled between the optical coupler and the detector. The gating function device removes at least one saturation event from the light reflected back from the device under test before directing the reflected light to the detector. A saturation event is a portion of the light reflected back from the device under test that otherwise would saturate the detector. The operation of the gating function device is controlled by at least one gating signal provided by the processor to the gating function device. The gating signal received by the gating function device from the processor is based on at least one characteristic of the saturation event.

### BRIEF DESCRIPTION OF THE DRAWINGS

FIG. 1 is a schematic diagram of a conventional optical time domain reflectometer (OTDR);

FIG. 2 is a schematic diagram of an optical time domain reflectometer (OTDR) having an internal gating function device, according to embodiments of the invention;

FIG. 3 is a schematic diagram of an optical time domain reflectometer (OTDR) having an external gating function device, according to embodiments of the invention;

FIG. 4 is a schematic diagram of an embodiment of the gating function device shown in FIG. 2 and FIG. 3, according to embodiments of the invention; and

FIG. 5 is a schematic diagram of an alternative embodiment of the gating function device shown in FIG. 2 and FIG. 3, according to embodiments of the invention;

FIG. 6 is a schematic diagram of an optical time domain reflectometer (OTDR) display showing a plot of an optical signal reflected from a device under test, according to embodiments of the invention; and

FIG. 7 is a flow diagram of a method for testing optical devices using an optical time domain reflectometer (OTDR), according to embodiments of the invention.

### DETAILED DESCRIPTION OF EXEMPLARY EMBODIMENTS

In the following description like reference numerals indicate like components to enhance the understanding of the invention through the description of the drawings. Also, although specific features, configurations and arrangements are discussed hereinbelow, it should be understood that such is done for illustrative purposes only. A person skilled in the relevant art will recognize that other steps, configurations and arrangements are useful without departing from the spirit and scope of the invention.

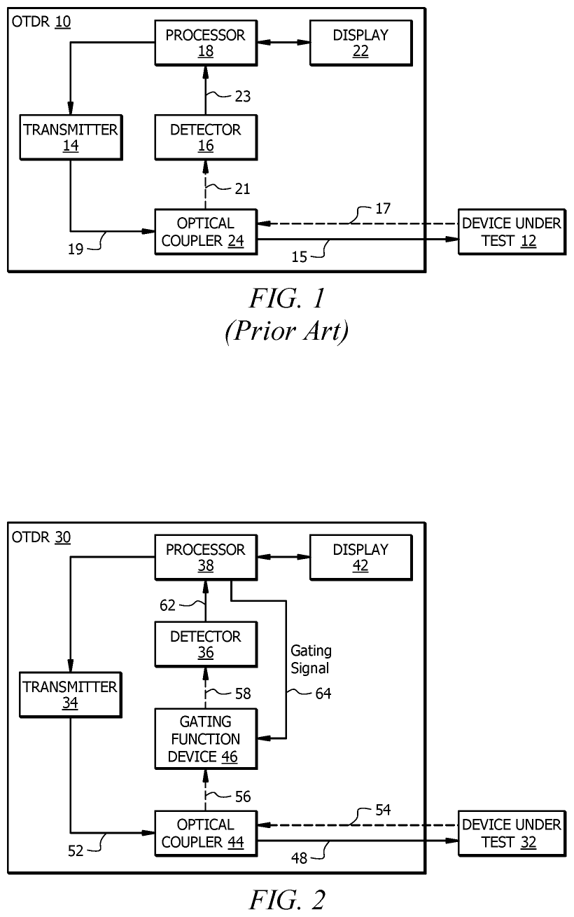

FIG. 1 is a schematic diagram of a conventional optical time domain reflectometer (OTDR) 10. An OTDR is an optoelectronic instrument used to characterize a device under test 12, such as an optical fiber. For example, an OTDR can be used for estimating the length of an optical fiber. An OTDR also can be used to determine the localized and overall attenuation of the optical fiber, including splice and mated-connector losses. An OTDR also can be used to locate faults, such as breaks, and to measure optical return loss.

The OTDR 10 includes a transmitter 14 that generates a series of optical pulses (shown as 15) that is sent by the OTDR 10 into the device under test 12. The transmitter 14 can include a laser source and a pulse generator (or other suitable components) that, in combination, transmit a series of optical pulses as determined by a processor 18 coupled to the transmitter 14.

The processor 18 determines and controls the duration and frequency (repetition rate) of the optical pulses sent by the transmitter 14 to the device under test 12. The processor 18 also controls any delay time in the transmitter 14 sending the optical pulses to the device under test 12.

The OTDR 10 also includes a detector 16 that receives or extracts light that is scattered or reflected back from points along the device under test 12 (shown as 17). The detector 16 can be a photoreceiver, or other suitable component or combination of components, that is adapted to receive light scattered or reflected back from points along the device under test 12.

The OTDR 10 also includes an optical coupler 24 coupled to the transmitter 14, e.g., via an optical fiber or other suitable coupling device (shown as 19). The optical coupler 24 receives the optical pulses transmitted from the transmitter 14 at a first port and directs the optical pulses to the device under test 12 from a second port. The optical coupler 24 also receives light scattered or reflected back from the device under test 12 (shown as 17) at the second port and directs the received light to the detector 16 (shown as 21) from a third port. The optical coupler 24 can be an optical circulator, or other suitable component or combination of components, that separates the optical pulses transmitted from the transmitter 14 from the light reflected back from the device under test 12.

The reflected light received by the detector 16 from the optical coupler 24 (shown as 21) is converted to an electrical signal and directed to the processor 18 (shown as 23). The strength of these return pulses received by the detector 16 is measured and integrated as a function of distance or time by the processor 18. The result is plotted as a function of distance (e.g., optical fiber length) or time, e.g., by a display 22 coupled to the processor 18.

As discussed hereinabove, relatively strong backreflection from the device under test should be reduced to avoid saturating the OTDR detector. The OTDR detector, which has a finite dynamic range, will enter a saturated response regime when hit with relatively high optical power, e.g., strong backreflection from the device under test. Also, the sensitivity of an OTDR detector has a recovery time or recovery cycle, and once the OTDR detector receives a sufficiently high power optical pulse, the OTDR detector will be “blinded” for a period of time during this recovery cycle. The duration of the OTDR detector recovery cycle has an exponential dependence on the power of the received optical pulse.

This problem of OTDR detector saturation is particularly acute during the measurement of hollow core optical fibers. Hollow core optical fibers typically are spliced or otherwise connected at each end to solid core optical fibers. The junction between the hollow core optical fiber and the solid core optical fiber results in a relatively high reflective air/glass interface, which typically produces a return loss on the order of approximately 14.4 decibels (dB). Such reflection usually will saturate the OTDR detector. Also, because many current optical links involving hollow core optical fiber are typically less than 500 meters in length, the recovery cycle of a saturated OTDR detector is greater than the time it takes the OTDR detector to receive almost the entire OTDR signal from along the hollow core optical fiber. Therefore, the OTDR detector saturation effectively “blinds” or obliterates essentially all of the OTDR signal received by the OTDR detector from along the hollow core optical fiber.

As discussed hereinabove, conventional solutions to this OTDR detector saturation problem typically involve cleaning optical connectors and angled cleaves within the device under test to prevent relatively strong reflections. Also, the use of relatively long lead-in optical fibers to the device under test have been used conventionally to reduce the effect of reflections at the launch point. However, such conventional solutions are not useful (or easily applied) when using hollow core optical fibers because the relatively high reflection is due to the optical fiber core constituents (e.g., air vs. glass).

According to an embodiment of the invention, the OTDR detector is protected from relatively strong reflections from a device under test. As will be discussed in greater detail hereinbelow, a gating function device is used to remove or attenuate relatively strong reflections from the return optical signal path from a device under test. According to an embodiment of the invention, the gating function device can be an internal component within the OTDR. Alternatively, the gating function device can be an external component coupled to the OTDR.

FIG. 2 is a schematic diagram of an optical time domain reflectometer (OTDR) 30, according to embodiments of the invention. The OTDR 30 is used to characterize a device under test 32, e.g., a hollow optical fiber, coupled to the OTDR 30. As will be discussed in greater detail hereinbelow, the OTDR 30 includes a transmitter 34, a detector 36, a processor 38, a display 42 and an optical coupler 44. Also, according to an embodiment of the invention, the OTDR 30 also includes a gating function device 46, as will be discussed in greater detail hereinbelow.

The transmitter 34, which can include a laser source and a pulse generator (or other suitable components), sends an optical signal, i.e., a series of optical pulses (shown as 48), to the device under test 32 via the optical coupler 44. The optical coupler 44 is coupled to the transmitter 34 via an optical fiber or other suitable coupling device (shown as 52). The optical coupler 44 receives the optical pulses transmitted from the transmitter 34 at a first port and directs the optical pulses to the device under test 32 from a second port.

The processor 38 determines and controls the duration and frequency of the optical pulses sent by the transmitter 34 to the device under test 32. The processor 38 also controls any delay time in the transmitter 34 sending the optical pulses to the device under test 32.

The optical coupler 44 receives light that is scattered or reflected back from points along the device under test 32 (shown as 54) and directs the scattered or reflected light 54 to the detector 36 via the gating function device 46. More specifically, the optical coupler 44 receives the scattered or reflected light 54 at the second port and directs that light (shown as 56) to the gating function device 46 via a third port. The optical coupler 44, which can be an optical circulator or other suitable component or combination of components, separates the optical pulses 48 transmitted to the device under test 32 from the light 54 reflected back from the device under test 32.

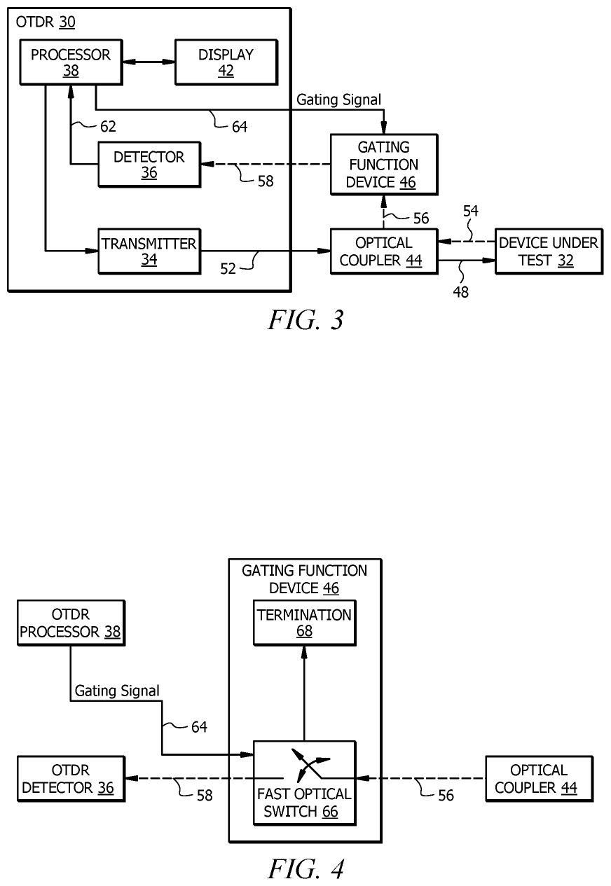

According to an embodiment of the invention, the detector 36 is protected from relatively strong reflections from the device under test 32 by the gating function device 46. As will be discussed in greater detail hereinbelow, the gating function device 46 is used to either remove or suitably attenuate relatively strong reflections from the return optical signal path 54 from the device under test 32. The operation of the gating function device 46 is controlled by a gating signal 64 from the processor 38. As shown in FIG. 2, the gating function device 46 is an internal component within the OTDR 30. Alternatively, as shown in FIG. 3, the gating function device 46 can be an external component coupled to the OTDR 30, e.g., if the optical coupler 44 is located external to the OTDR 30.

The reflected light output from the gating function device 46 (shown as 58) is received by the detector 36. The detector 36, which can be a photoreceiver or other suitable component or combination of components, receives the reflected light 58 output from the gating function device 46, converts it to an electrical signal, and directs the signal (shown as 62) to the processor 38.

The processor 38 measures the strength of the electrical signal 62 received from the detector 36 and integrates the measurements as a function of distance or time. The result is plotted as a function of distance (e.g., optical fiber length) or time, e.g., by the display 42 coupled to the processor 38.

FIG. 4 is a schematic diagram of an embodiment of the gating function device 46 shown in FIG. 2 and FIG. 3, according to embodiments of the invention. The gating function device 46 includes a fast optical switch 66 coupled between the optical coupler 44 and the detector 36. The fast optical switch 66 receives the reflected light 56 directed from the optical coupler 44 and, when the fast optical switch 66 is closed, directs the reflected light to the detector 36 (shown as 58). When the fast optical switch 66 is open, the fast optical switch 66 directs the reflected light 56 received from the optical coupler 44 to a low reflection optical termination component 68 coupled to the fast optical switch 66 within the gating function device 46.

Accordingly, the fast optical switch 66 within the gating function device 46 is able to redirect the reflected light 56 from the optical coupler 44 away from the detector 36, e.g., when relatively strong reflections occur in the reflected light 56, thereby blocking or preventing relatively strong reflections from being received by the detector 36. For example, if the reflected light 56 from the optical coupler 44 does not have a relatively strong reflection, the fast optical switch 66 is closed and the reflected light is directed to the detector 36. However, if the reflected light 56 from the optical coupler 44 includes a relatively strong reflection, the fast optical switch 66 is opened and the reflected light is redirected to the low reflection optical termination component 68, thereby effectively removing the large reflection from the optical signal path to the detector 36.

The operation of the fast optical switch 66 is controlled by a gating signal 64 received by the processor 38. For example, the fast optical switch 66 toggles between an open position and a closed position each time the fast optical switch 66 receives a gating signal 64 from the processor 38. Alternatively, the fast optical switch 66 opens when the fast optical switch 66 receives a first type of gating signal 64 from the processor 38 and closes when the fast optical switch receives a second type of gating signal 64 from the processor 38.

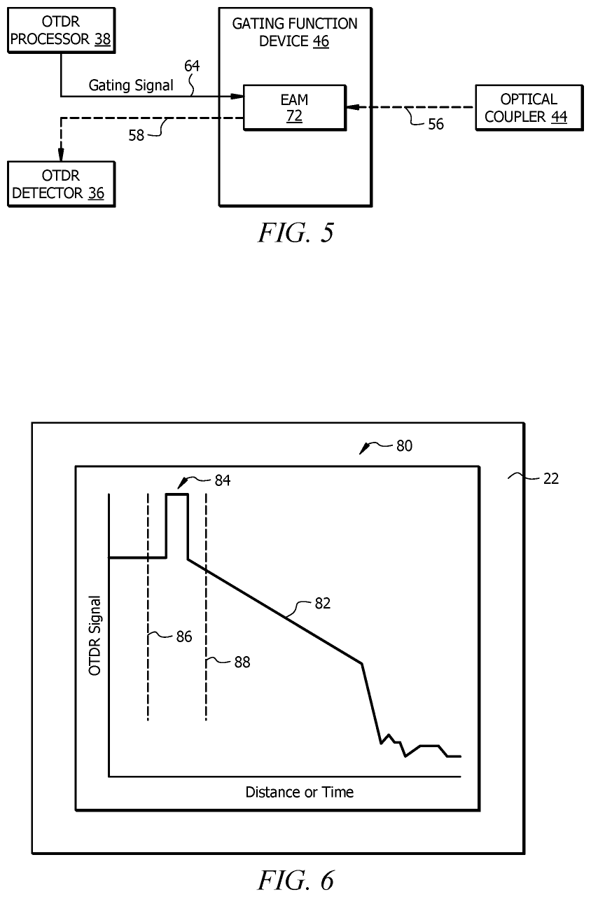

FIG. 5 is a schematic diagram of an alternative embodiment of the gating function device 46 shown in FIG. 2 and FIG. 3, according to embodiments of the invention. The gating function device 46 includes an electro-absorption modulator (EAM) 72 (or other suitable component or combination of components) coupled between the optical coupler 44 and the detector 36. The EAM 72 modulates the intensity of the reflected light 56 received by the optical coupler 44 and directed to the detector 36 in response to the gating signal 64 received from the processor 38.

Accordingly, the EAM 72 within the gating function device 46 is able to attenuate the reflected light 56 received from the optical coupler 44 prior to the reflected light 58 being directed to and received by the detector 36, e.g., when relatively strong reflections occur in the reflected light 56, thereby removing relatively strong reflections from the reflected light 56 received from the optical coupler 44 prior to the detector 36 receiving reflected light 58 from the gating function device 46. In this manner, the EAM 72 within the gating function device 46 eliminates any relatively strong reflections in the reflected signal path being received by the detector 36.

For example, when the EAM 72 does not receive a gating signal 64 from the processor 38, the EAM 72 does not attenuate the reflected light 56 received by the optical coupler 44 and directs the non-attenuated reflected light 58 to the detector 36. However, when the EAM 72 receives a gating signal 64 from the processor 38, the EAM 72 attenuates the reflected light 56 received by the optical coupler 44 and directs the attenuated reflected light 58 to the detector 36. Alternatively, the operation of the EAM 72 can be controlled by different types of gating signals received by the processor 38. For example, if the EAM 72 receives a first type of gating signal 64 from the processor 38, the EAM 72 does not attenuate the reflected light 56 received by the optical coupler 44. However, if the EAM 72 receives a second type of gating signal 64 from the processor 38, the EAM 72 attenuates the reflected light 56 received by the optical coupler 44.

FIG. 6 is a schematic diagram of an optical time domain reflectometer (OTDR) display 22 showing a plot 80 of a processed optical signal 82 reflected from a device under test, according to embodiments of the invention. The plot 80 shows the strength of the reflected optical signal (y-axis), typically in decibels (dB), as a function of either distance or time (x-axis).

If the reflected optical signal 82 includes a relatively strong optical reflection, this relatively strong optical reflection typically appears on the display 22 as a spike (shown as 84). As discussed hereinabove, this relatively strong optical reflection will saturate the detector, causing the detector to be “blinded” into a saturation state. This “saturation event” will prevent subsequent reflected (or backscattered) optical signals from being displayed until the detector recovers from its saturation state. It should be understood that a saturation event is defined as a portion of the reflected optical signal strong enough to saturate the detector. As discussed hereinabove, saturating the detector occurs when a sufficiently high power optical pulse “blinds” the detector, thereby masking downstream OTDR events, at least until the detector completes its recovery cycle.

According to an embodiment of the invention, once a saturation event 84 is identified or determined to exist, the saturation event 84 is defined or characterized, e.g., by its size and by its relative position. That is, the saturation event 84 is defined or characterized by its width (distance or time) and by its delay from the time an initial optical pulse is transmitted from the OTDR to the device under test. For example, on the display 22, cursors 86, 88 are placed on either side of the saturation event 84, thereby defining or characterizing the width (or gate width) of the saturation event 84. Also, the relative position of the cursors 86, 88 along the x-axis defines or characterizes the delay (or gate delay) of the saturation event 84 relative to the corresponding optical pulse transmitted from the OTDR to the device under test.

According to an embodiment of the invention, once the saturation event 84 has been defined or characterized, the OTDR processor 38 provides an appropriate gating signal 64 to the gating function device 46 based on the ascertained characteristics of the saturation event 84. The gating signal 64, in turn, causes the gating function device 46 to either redirect the saturation event 84 (if the gating function device 46 is a fast optical switch 66) or attenuate the saturation event 84 (if the gating function device 46 is an EAM 72). According to an embodiment of the invention, the gating signal 64 (and therefore the operation of the gating function device 46) is synchronized to the repetition rate of the optical pulse transmitted from the OTDR to the device under test, based on the defined gate width of the saturation event 84. Also, the gating signal 64 (and therefore the operation of the gating function device 46) is delayed to coincide with the reflection of the saturation event 84, based on the defined gate delay of the saturation event 84.

In this manner, the gating function device 46 is able to either redirect or attenuate the saturation event 84 from the reflected optical signal before the optical signal reaches the detector 38. The detector 38 therefore does not “see” or detect the saturation event 84 because the saturation event 84 has been removed from the reflected optical signal path prior to the reflected optical signal path reaching the detector 38. Accordingly, the detector 38 is not “blinded” by the eliminated saturation event and therefore the detector 38 does not enter a saturation state. With the saturation event 84 having been successfully removed from the reflected optical signal path, the detector 36 is able to properly detect the reflected optical signal (except at the exact point of the saturating reflection), which then can be plotted by the OTDR display 22.

According to an embodiment of the invention, defining or characterizing a saturation event is performed automatically by the OTDR, e.g., via the processor. In this manner, the OTDR automatically finds saturation points on the plot 80 of the processed optical signal 82 and creates a corresponding gating signal 64. A user of the OTDR can possibly interact with the automatic process by activating the process and/or confirming or approving the process results. The automatic process also can set (or prompt a user to set) an appropriate “saturation level,” which corresponds to a suitable masking tolerance near reflection points along the plot 80 of the processed optical signal 82.

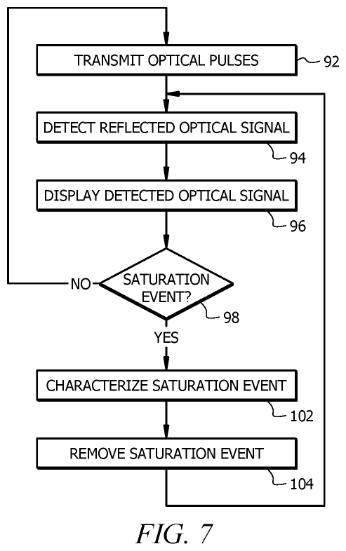

FIG. 7 is a flow diagram of a method 90 for testing optical devices using an optical time domain reflectometer (OTDR), according to embodiments of the invention. The method 90 includes a step 92 of transmitting optical pulses. As discussed hereinabove, a transmitter within the OTDR generates and transmits a series of optical pulses to a device under test. A processor within the OTDR controls the duration, frequency (repetition rate), delay time and other suitable parameters for the transmitter sending optical pulses to the device under test.

The method 90 also includes a step 94 of detecting a reflected optical signal. As discussed hereinabove, a detector within the OTDR receives or extracts light that is scattered or reflected back from points along the device under test.

The method 90 also includes a step 96 of displaying the reflected optical signal. As discussed hereinabove, the detected light reflected back from the device under test is converted to an electrical signal and processed for display by a display within the OTDR. The detected signal is displayed as an amplitude or signal strength, e.g., in decibels, as a function of time or distance.

The method also includes a step 98 of determining whether a saturation event has occurred, i.e., if the reflected optical signal includes a relatively strong optical reflection portion that is strong enough to saturate the detector, causing the detector to be “blinded” into a saturation state. When viewed on the display, the saturation event typically appears as a spike.

If a saturation event has not occurred (NO), the method 90 returns to the transmitting step 92. That is, if no portion of the reflected optical signal includes a relatively strong optical reflection or spike that is strong enough to saturate the detector, the method 90 returns to the transmitting step 92.

The method also includes a step 102 of characterizing the saturation event. According to an embodiment of the invention, if a saturation event has occurred (YES), the characterizing step 102 characterizes the identified saturation event. As discussed hereinabove, the saturation event is defined or characterized, e.g., by its size and by its relative position. That is, the saturation event is defined or characterized by its width (distance or time) and by its delay from the time an initial optical pulse is transmitted from the OTDR to the device under test.

The method also includes a step 104 of removing the saturation event form the reflected optical signal. According to an embodiment of the invention, once the saturation event has been identified and defined or characterized, the saturation event is removed from the reflected optical signal. As discussed hereinabove, a gating function device either redirects or attenuates the saturation event, thereby effectively removing the saturation event form the reflected optical signal. The gating device is controlled by an appropriate gating signal supplied by the OTDR processor and based on the defined characteristics of the saturation event. For example, the operation of the gating function device is synchronized to the repetition rate of the optical pulse transmitted from the transmitter to the device under test, based on the defined gate width of the saturation event. Also, the operation of the gating function device is delayed to coincide with the reflection of the saturation event, based on the defined gate delay of the saturation event.

It should be understood that embodiments of the invention can be used in other applications, e.g., for other reflection-based optical measurements, such as optical backscatter reflectometers (OBRs). Also, it should be understood that implementation of embodiment of the invention may vary accordingly because OBRs and similar instruments are wavelength-based, rather than time based.

It will be apparent to those skilled in the art that many changes and substitutions can be made to the embodiments of the invention herein described without departing from the spirit and scope of the invention as defined by the appended claims and their full scope of equivalents.

1. An optical time domain reflectometer (OTDR) device, comprising:
a transmitter for generating and transmitting a series of optical pulses;
a processor coupled to the transmitter for controlling the duration and frequency of the optical pulses transmitted by the transmitter;
an optical coupler coupled to the transmitter for receiving the optical pulses from the transmitter, wherein the optical coupler directs the optical pulses received from the transmitter to a device under test coupled to the OTDR, and wherein the optical coupler receives light reflected back from the device under test;
a detector coupled to the processor for receiving light reflected back from the device under test and converting the reflected light to an electrical signal;
a display coupled to the processor for displaying a plot of the electrical signal; and
a gating function device coupled between the optical coupler and the detector, wherein the gating function device removes at least one saturation event from the light reflected back from the device under test before directing the reflected light to the detector, wherein a saturation event is a portion of the light reflected back from the device under test that otherwise would saturate the detector,
wherein the operation of the gating function device is controlled by at least one gating signal provided by the processor to the gating function device, wherein the gating signal received by the gating function device from the processor is based on at least one characteristic of the saturation event.

2. The OTDR device as recited in claim 1, wherein the at least one characteristic of the saturation event includes the width of the saturation event and the delay of the saturation event relative to a corresponding optical pulse transmitted by the transmitter.

3. The OTDR device as recited in claim 1, wherein the at least one characteristic of the saturation event is determined based on the plot of the light reflected back from the device under test.

4. The OTDR device as recited in claim 1, wherein the gating function device includes a fast optical switch coupled between the optical coupler and the detector and a low reflection optical termination component coupled to the fast optical switch, wherein the fast optical switch directs light reflected back from the device under test and received by the optical coupler to the detector when the fast optical switch is closed, wherein the fast optical switch redirects light reflected back from the device under test and received by the optical coupler to the low reflection optical termination component when the fast optical switch is open, wherein the fast optical switch closes in response to receiving a first gating signal from the processor, and wherein the fast optical switch opens in response to receiving a second gating signal from the processor.

5. The OTDR device as recited in claim 1, wherein the gating function device includes an electro-absorption modulator (EAM) coupled between the optical coupler and the detector, wherein the EAM attenuates light reflected back from the device under test and received by the optical coupler in response to receiving a gating signal from the processor.

6. The OTDR device as recited in claim 1, wherein the optical coupler and the gating function device are internal to the OTDR.

7. The OTDR device as recited in claim 1, wherein the optical coupler and the gating function device are external to the OTDR and coupled thereto.

8. The OTDR device as recited in claim 1, wherein the transmitter includes a laser source and a pulse generator.

9. The OTDR device as recited in claim 1, wherein the optical coupler is an optical circulator that separates optical pulses received by the transmitter from light reflect back from the device under test.

10. The OTDR device as recited in claim 1, wherein the detector is a photoreceiver.

11. The OTDR device as recited in claim 1, wherein the device under test is a hollow optical fiber.

12. A method for testing an optical device under test, comprising:
transmitting a series of optical pulses to the device under test;
receiving light reflected back from the device under test;
detecting the light reflected back from the device under test;
converting the light reflected back from the device under test to an electrical signal;
displaying a plot of the electrical signal;
removing at least one saturation event from the light reflected back from the device under test, wherein a saturation event is a portion of the light reflected back from the device under test that otherwise would saturate the detection of the light reflected back from the device under test; and
controlling the removal of the saturation event based on at least one characteristic of the saturation event.

13. The method as recited in claim 12, wherein the at least one characteristic of the saturation event includes the width of the saturation event and the delay of the saturation event relative to a corresponding transmitted optical pulse.

14. The method as recited in claim 12, wherein at least one characteristic of the saturation event is determined based on the plot of the light reflected back from the device under test.

15. The method as recited in claim 12, wherein removing at least one saturation event from the light reflected back from the device under test further comprises redirecting light reflected back from the device under test to a low reflection optical termination component.

16. The method as recited in claim 12, wherein removing at least one saturation event from the light reflected back from the device under test further comprises attenuating light reflected back from the device under test.

17. The method as recited in claim 12, wherein the device under test is a hollow optical fiber.
